(19) United States
(12) Patent Application Publication
(10) Pub. No.: US 2009/0079182 A1
(43) Pub. Date: Mar. 26, 2009

(54) Care Card

(76) Inventors: Elizabeth T. Dold, Fairfax, VA (US); Lynlee C. Baker, Oakton, VA (US)

Correspondence Address: TECHNOLOGY & INNOVATION LAW GROUP, PC, 19200 STEVENS CREEK BLVD., SUITE 240, CUPERTINO, CA, 95014, US

(21) Appl. No.: 12/024,312

(22) Filed: Feb. 1, 2008

Related U.S. Application Data
(60) Provisional application No. 60/974,739, filed on Sep. 24, 2007.

(51) Int. Cl. B42D 15/10

(52) U.S. Cl. 283/72

(57) ABSTRACT

Improved ways to facilitate the collection and distribution of donations are disclosed. One aspect involves the creation and administration of charitable donation cards. Another aspect involves the creation and administration of charitable donation cards and care cards. Still another aspect of the invention involves creation, distribution and administration of drug sample cards.

### CROSS-REFERENCE TO RELATED APPLICATION

This application claims priority of U.S. Provisional Patent Application No. 60/974,739, filed Sep. 24, 2007, and entitled “CARE CARD,” which is hereby incorporated by reference herein.

### BACKGROUND OF THE INVENTION

1. Field of the Invention

The present invention relates to charitable donations and, more particularly, to methods for facilitating charitable donations and charitable distributions.

2. Description of the Related Art

To make a charitable donation, donors can give cash, give property, or purchase products. A donor can also use a credit or debit card to make a donation. In some cases, the donation can be specified to be for specific charitable purposes. Recently, on-line donations have been used to make charitable donations.

Currently, when a charity (or other for-profit organization or governmental entity, hereinafter, “charity”) wishes to distribute funds to charity recipients (i.e., donees), it has limited options, especially when it wants to ensure that funds are used properly. It is not ideal to simply hand out cash or checks to donees, since neither has any built-in restrictions on their use. Gift cards are one solution, but may be too limiting as they are typically only usable at one merchant chain, do not restrict the use of the card, do not denote the charity or the charity's efforts. Alternately, a charity might require that a donee provide receipts to verify that charity funds have been used properly. However, this adds administrative complexity, both for the donee and the charity.

Thus there is a demand for improved methods for gathering and distributing charitable funds and ensuring that they are used for their intended purpose.

### SUMMARY OF THE INVENTION

The invention pertains to ways to facilitate the collection and distribution of donations. One aspect of the invention involves the creation and administration of charitable donation cards. Another aspect of the invention involves the creation and administration of charitable donation cards and care cards. Still another aspect of the invention involves creation, distribution and administration of drug sample cards.

According to one embodiment of the invention, a charitable donation card (charity donor card) can be sold (or distributed) to purchasers (or individuals) as various retail locations, special events, vending machines, donation kiosks, online (e.g., websites). The charitable donation card has no value on being purchased but serves as a reminder, symbol or receipt of a charitable donation.

According to another embodiment of the invention, a care card, funded by charitable donations is disclosed. The care card can be pre-funded (or re-loaded), for example, from the sale of charitable donation cards, grants, charitable fundraising, etc. The care card can be highly customized, including custom graphics, text and a custom form factor.

According to another embodiment of the invention, a limited-purpose charity-sponsored (or co-sponsored) debit card, pre-funded (and re-loadable) by charitable donations distributed to donees that satisfy the needs requirements of the charity is disclosed (the care card). The care card can be funded, for example, from the sale/use of charitable donation cards. The embodiment of both the charitable donation card and the care card care can be highly customized, including custom graphics, text and a custom form factor (including, size, shape, logos, messages, and cost codes).

The limitations of the care card can be set by the issuing charity to meet the specific needs of the charity's mission. Examples of limited purposes are, for example, medical expenses (e.g., drugs, hospital bills, surgery, rehabilitation, medical tests (e.g., mammogram), groceries, computers, housing expenses, child-care, household expenses, and home repair expenses. This is key to safeguarding the use of charitable contributions and satisfying the charity's mission.

According to still another embodiment of the invention, a donation card can be a drug sample card that can be used to facilitate distribution of a drug. As an example, the drug sample card can include one or more of: sponsor information, drug information; a drug prescription region; or a unique card identifier assigned to the drug sample card.

Other aspects and advantages of the invention will become apparent from the following detailed description taken in conjunction with the accompanying drawings which illustrate, by way of example, the principles of the invention.

### BRIEF DESCRIPTION OF THE DRAWINGS

FIG. 1 is a block diagram of a charitable donation card, according to one embodiment of the invention.

FIG. 2 is a diagram of a care card, according to one embodiment of the invention.

FIG. 3 is a flow diagram of a care card creation process, according to one embodiment of the invention.

FIG. 4 is a block diagram of a charitable donation card/care card administration system according to one embodiment of the invention.

FIGS. 5A and 5B are diagrams of a drug sample card according to one embodiment of the invention.

### DETAILED DESCRIPTION OF THE INVENTION

The invention pertains to ways to facilitate the collection and distribution of donations (which includes amounts contributed by non-profit or for-profit organizations). One aspect of the invention involves the creation and administration of charitable donation cards. Another aspect of the invention involves the creation and administration of limited purpose care cards, which are a means of distributing charitable donations either directly to the end user or through an organization or agency. Still another aspect of the invention involves creation, distribution and administration of drug sample cards.

According to one embodiment of the invention, a charitable donation card (charity donor card) can be sold (or distributed) to purchasers (or individuals) as various retail locations, special events, vending machines, donation kiosks, online (e.g., websites). The charitable donation card has no value on being purchased but serves as a reminder, symbol or receipt of a charitable donation. In one embodiment, the charitable donation card can also serve as a means to make (and prompt) additional contributions at various retail locations, special events, on-line, and donation kiosks, churches, hospitals, online, etc. through the use of the charitable donation card. The charitable donation card can be highly customized, including custom graphics, text and a custom form factor (including, size, shape, logos, messages, and cost codes). The limitations of the care card can be set by the issuing charity to meet the specific needs of the charity's mission. Examples of limited purposes are, for example, medical expenses (e.g., drugs, hospital bills, surgery, rehabilitation, medical tests (e.g., mammogram), groceries, computers, housing expenses, child-care, household expenses, and home repair expenses. This is key to safeguarding the use of charitable contributions and satisfying the charity's mission.

According to another embodiment of the invention, a care card, funded by charitable donations is disclosed. The care card can be pre-funded (or re-loaded), for example, from the sale of charitable donation cards, grants, charitable fundraising, etc. The care card can be highly customized, including custom graphics, text and a custom form factor (including, size, shape, logos, messages, and cost codes).

A charitable donation card can be used to facilitate the collection of contributions to a particular charity or fundraising event. The charitable donation card can resemble a store gift card. However, no amount of the purchase price of the charitable donation card is available for purchases. Instead, the purchase price of the card is used to fund a charitable donation, typically for a particular charitable organization, a specific charity event, or towards a particular charity fundraising goal. Rather than a store credit, the purchase of the charitable donation card makes a cash (including credit/debit transactions) contribution for charitable purposes. The purchaser of the charitable donation card can be considered a donor. In one embodiment of the invention, the charitable donation card can also constitute the donor's receipt for tax purposes. The face value on the card can represent the donor's charitable contribution. The face value of the card, less a processing fee, will go to the charity. The card itself can also serve as is a marketing device to gain awareness for a charitable organization or fund-raising event.

A charity can also make available an accounting of a donor's charitable giving online. The accounting can be from charitable donation cards, online donations, etc. and include information such as time, date, charitable purpose, and amount of charitable donation.

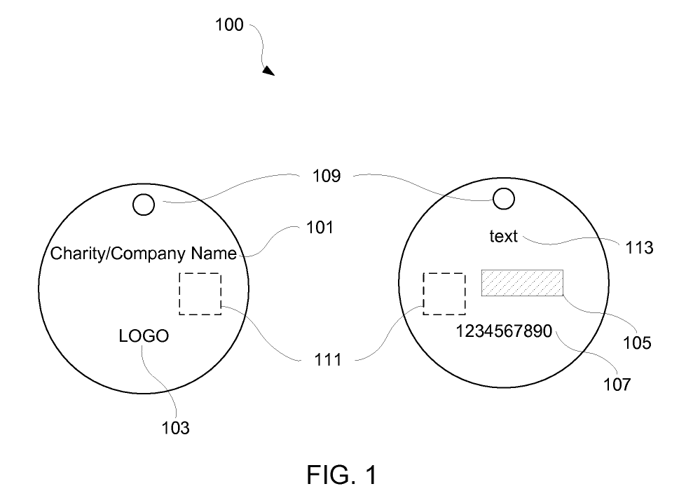

FIG. 1 is a block diagram of a charitable donation card 100, according to one embodiment of the invention. The charitable donation card 100 can be a die-cut plastic card. One side of the charitable donation card 100 can be labeled with a charity and/or corporate sponsor name 101 and one or more logos 103. On the reverse side of the charitable donation card 100, an identifying strip 105 and/or an identifying number 107 can be included. The identifying strip 105 can be a magnetic strip, for example, and/or a bar-code.

According to one embodiment of the invention, the charitable donation card 100 has a custom form-factor, for example, a shape selected by the sponsoring charitable organization. The custom form-factor is not limited to rectangular shapes and thus may include more complex shapes such as spheres, heart-shapes, cubes, or other shapes as determined by the charity. Any material can be used as well, including plastic, wood or metal enclosures. By way of example, a charity might create a charitable donation card in the shape of a charity event mascot.

The charitable donation card 100 can also include a connection 109 for a key chain, lanyard, or clip. The connection 109 can, for example, be an opening or hole in the charitable donation card 100. The charitable donation card 100 can include a magnetic strip, a UPC symbol or barcode, or an embedded computer chip in any of its configurations.

Additional contributions made with the donation card by the donor can be maintained by an administrator for such cards. Donors can access an accounting of the donor's contributions via the charity's website.

The charitable donation card, in one embodiment, can be customized to include the individual favorite charities, and an accounting of the contributions is available through the administrator's website for tax purposes. A donor could also use the card to allocate future donations to other charities.

According to still another embodiment of the invention, the charitable donation card 100 can contain an electronic chip 111 that adds additional functionality. For instance, the electronic chip 111 can be wirelessly programmed with whatever information the charity or user wishes to associate with the charitable donation card 100. The programmed information can be machine readable. The programmed information can provide a total of the contribution by the donor (or a group) and/or a total of a general charitable goal being sought by the charity. In one embodiment, the charitable donation card 100 can be a multi-purpose card that not only provide charitable donations but also communicates with a building access system to allow access to a particular building. In another embodiment, the electronic chip 111 could be coupled to a display (not shown) which indicates a fundraising goal, matching contributions or show total charity donations for the card holder or group of card holders, or other information. Such a display can also display a time, date or countdown (for a donation or a charity goal).

The look of each charitable donation card can be customized by the charity and/or associated charity sponsors (i.e., corporate sponsors). For example, if a retail store is co-sponsoring the card, the logos 103 can include both the retail store logo and a charity logo. In addition, the charitable donation card 100 can include additional text 113. The text 113 can, for example, explain the specific purpose of the charitable donation being made. The text can, for example, disclose relevant information for tax purposes (e.g., the charity registration or identification number.) Alternately, the card 100 can include instructions or information on the face or on any surface. The additional text 113 can, for example, include a donation amount on the card, charity contact information or a web address, etc.

In one embodiment of the invention, the charitable donation card 100, or its packaging (not shown), can contain a charity identification code (e.g., a bar code) that indicates what charity(s)/sponsor(s) will receive the funds. If the charity/sponsor has a number of different cards for various fundraising efforts, the charity identification code can indicate various charity sub-accounts. In another embodiment, the charitable donation card can contain multiple identification codes and the donor can make the selection of the codes depending on the particular charity, charitable purpose, or charitable event to receive the donation. The packaging can also include a token item for the donor that shows the donor's support and a thank you note from the charity. The charitable donation card 100 can also be packaged with a token item (e.g., gift) to the donor. In the case of the inclusion of a gift to the donor, the charitable donation card reflects the amount of the charitable contribution, not the total purchase price. For example, a pin can be included in the packaging. The selling price for the package could be $25, with the charity card 100 indicating a value of $20 because of the reduction in value for the fair market value of the pin. The donor would get the pin along with credit for a charitable contribution of $20.

Alternatively, the packaging can also include a gift item for the donor to gift to another person and also a charitable donation card that shows the donor's support on behalf of the gift recipient for the charity. In such case, as an example, the individual can purchase an item for a gift (value $20) that includes a charity card for $5, with the total purchase price for the package being $25.

Alternative designs for a charitable donation card are disclosed in U.S. Design Pat. Application No. 29/295,252, filed Sep. 24, 2007, entitled “CARD,” and is hereby incorporated herein by reference.

According to another embodiment of the invention, the charitable donation card can have a removable casing that can be replaced, giving the ability to update or customize the look of the charitable donation card.

A charitable donation card 100 can be used in a number of different ways. For example, the charitable donation card 100 can be used to raise awareness and funds for a charity's general purposes. Alternately, a charitable donation card 100 can designate that funds collected will be contributed to support a specific fundraising event. For example, a charitable donation card 100 can say “Support the Avon Walk for Breast Cancer.” The charitable donation card 100 can also be used to raise money for a specific person or specific expenses, for example to fund an operation for a particular person, or the charitable donation card 100 can indicate that funds collected will be contributed to support a particular fundraising goal. For example, a school could sell the cards to raise money for new uniforms for the girl's swim team. Alternately, a charitable donation card 100 can indicate that the funds will be used to pay for expenses (e.g., medical expenses or any other type of expenses determined by the charity) for a class of persons that meets the needs requirements of the charity.

A charity and/or one or more corporate sponsors can align to raise money for the charity or a specific benefit goal or event. In this case, the charitable donation card 100 can indicate the co-sponsorship by displaying corporate graphics along with the charitable organization graphics. The charitable donation card 100 can also indicate if the retailer plans to match any percentage of the face value of the card. For example, if a corporate sponsor and a charity put together a one-day cancer awareness day, with the corporate sponsor promising to match 10% of all contributions made that day, a $30 gift card would indicate that the corporate sponsor will also contribute $3 to the cause.

To create a charitable donation card, a charity or sponsor can contact the charitable donation card creation company by telephone or online. A design team at the charitable donation card creation company then works with the charity to design the cards to specifications, and the order would be processed and the cards shipped. To safeguard the tax contribution in the event of theft of the cards, the donor/IRS can contact the charitable donation card creation company to ensure that card ID numbers are activated (which results upon sale) or that the card was not otherwise reported as stolen by the charity/sponsor.

The charitable donation card can be sold or distributed in a wide variety of venues, including, retail stores, on-line, at fundraising events, churches, hospitals, schools, restaurants, vending machine, workplace, online, and the charitable donation box. For additional information on a charitable donation box see U.S. patent application Ser. No. 11/874,827, filed Oct. 18, 2007, entitled “METHOD AND APPARATUS FOR FACILITATING CHARITABLE DONATIONS,” and is hereby incorporated herein by reference.

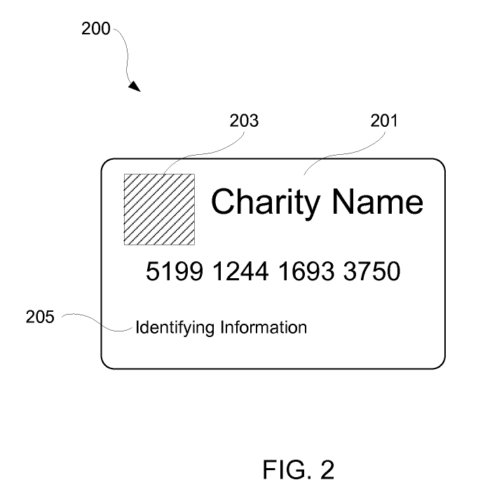

FIG. 2 is a diagram of a care card 200 according to one embodiment of the invention. A care card 200 can be created for use by charity recipients (i.e., donees). The details of the care card 200 can be described on the card.

A care card 200 is a debit card funded by charitable donations. The care card 200 can, for example, be issued by a bank or other financial institution. The uses to which a care card 200 are designated by the sponsoring charity/organization and can be administrated by a third party.

The care card 200 can appear similar to a common debit card. However, there are important differences, noted below including (1) charity sponsored, (2) restrict use for designated expenses, (3) for charitable purposes, and (4) support charitable mission. The care card 200 can, in one embodiment, be considered a limited-purpose charity sponsored debit card. The care card 200 shown includes a charity name 201 and charity logo 203 on the face of the card. Alternately, charity name 201 and charity logo 203 can be replaced or augmented by the names and logos of one or more corporate sponsors. A donee name 205 or other identifying information is also included on the face of the card. The reverse of the card (not shown) can include a magnetic strip and/or informational text, such as usage limitations for the care card 200 and/or contact information the charity or its corporate sponsors, for example.

A charity can establish a program to provide specific expenses that can be paid for with the care card 200. The charity can use a care card 200 program for general or specific goals, with the allowable expenses varied in accordance with those goals. Examples of limited purposes for charity-sponsored debit cards include: groceries, housing expenses, building materials, child-care, or medical expenses. A care card 200 can have whatever limitations the charity decides to enact, thus other limitations on the use of the care card 200 are possible (e.g., nontransferable, not convertible to cash, re-loadable or one-time use, signature requirement).

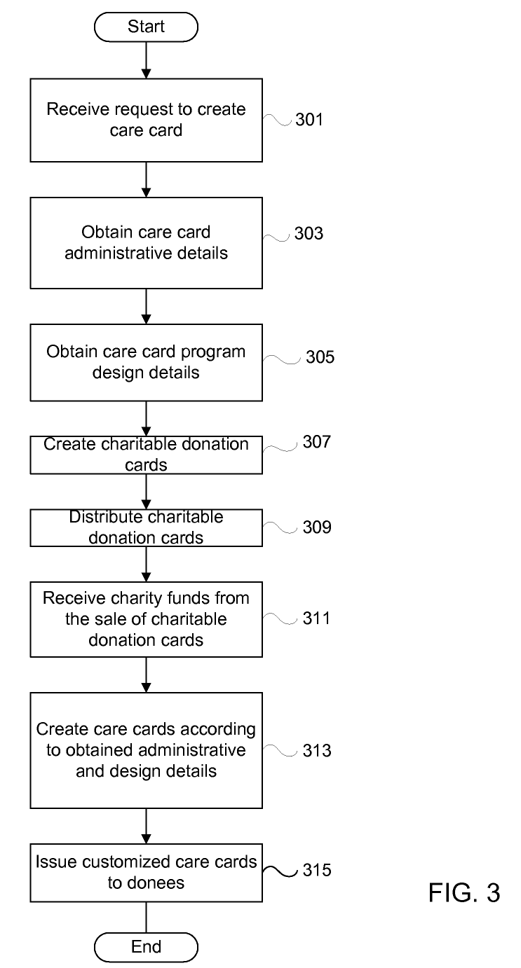

FIG. 3 is a flow diagram of a care card creation process 300, according to one embodiment of the invention. The care card creation process 300 can be used to create, for example, the care card 200 described above in FIG. 2, using funds generated by the sale of, for example, the charitable donation card 100 described above in FIG. 1.

The care card creation process 300 begins with receiving 301 a request to create a care card, for example by contacting the charity-sponsored debit card creation company by telephone or online. The care card administrative details are then obtained 303. The care card can, for example, include necessary information needed to fund and administer care cards created by the care card creation process 300.

Next, the design details for the care card are obtained 305, for example by working with a design team at the charity-sponsored debit card creation company to design the care cards to the charity's specifications, including the option to create custom shapes and custom graphics. The obtaining 305 can include obtaining design details for the creation of charitable donation cards that can be sold to fund care cards (or other charitable purposes of the charity).

Once the administrative details for the care cards have been obtained 303 and the design details for the care card have been obtained 305, the charitable donation cards can be created 307 and distributed 309 for use in facilitating charitable donations.

Next, funds are received 311 from the sale of charitable donation cards. In one embodiment, the received funds are then used to create 313 care cards so they can be issued 315 to the intended recipients (i.e., the charity donees) of the cards.

A care card can be distributed, for example, through a charitable donation registry or directly by the charity. The charitable donation registry/shopping cart can be linked to the charity's website. The charitable donation registry can allow certain individuals (who meet the charity's requirements) to register for the care card. The individuals can register themselves or another person can register for such individuals. In one embodiment of the invention, the charitable donation registry is similar to a gift registry with a retail store. However, the charitable donation registry can require additional information from registrants, such as medically-related information, for example (or other designated questions) to aid in determining if the individual is qualified to receive the charity's benefits. This allows the charity itself to distribute the requested care cards to those in need or allow individuals to purchase the care cards (which may qualify for a charitable donation) for those registrants in need. Individuals can also purchase the care cards for later in-person distribution to those in need (e.g., food care cards can be purchased on-line and distributed to a street person) rather than cash, to safeguard the use of the charitable card.

Alternatively, the charity can distribute the cards directly to an individual, group of individuals, organizations, etc. For example, the charity can raise $500,000 at a golf event and the proceeds can be used to purchase 1,000 debit cards, each for $500 and distribute them through a charitable donation registry or otherwise. The distribution of the care cards can be restricted by geographical location (to keep the proceeds in the community) or restricted in other ways (e.g., used for a specific person or type of person in the registry.)

To prevent the unauthorized use of a care card, such cards must first be activated. The donee that receives the care card can activate the card by, for instance, calling a toll-free number or visiting a web-site. The recipient can give, for example, their name, address, and phone number. If a postal or email address is supplied, then the donee can be mailed or emailed a description of the use of the card. Furthermore, if the name of the individual is not designated on the care card, the donee may activate the card in their name, provided that they can demonstrate that they meet the qualifications set forth by the charity to activate the card. For example, the charity that sponsors the care card can require registration in a gift registry, which can be customized to include the required qualifications for the gift. Additionally, where the care card is for medical or medically-related expenses, the donee's medical information or insurance information can be independently verified prior to activation of the card.

As noted above, in one embodiment of the invention, the care card is a restricted-use card, and the limitation can be indicated on the card itself. In order to enforce the limitations of the care card, a care card administrator can monitor the types of expenses being claimed and restrict the product codes that the card will be able to process (e.g., code medical expenses similar to administration of an employer sponsored flexible spending account). Additionally, the care card administrator can request additional documentation from a particular care card user in the event that a charge appears outside the charity's specifications. If no documentation is provided, the use (or any additional pre-funding) of the card can be suspended by the care card administrator. A list can be maintained for suspended card holders to prevent any further debit card use in the future. Also, merchants (including service provider) accepting the care card can be requested to monitor and restrict purchases to those approved given the limited-purpose of the charity-sponsored debit card.

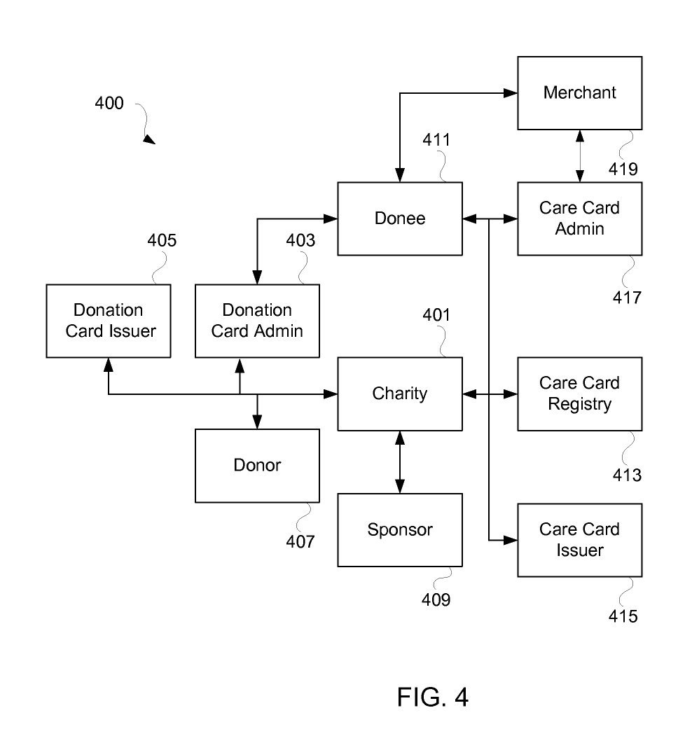

FIG. 4 is a block diagram of a charitable donation card/care card administration system 400 according to one embodiment of the invention. The charitable donation card/care card administration system is used to create, issue, administer, and distribute charitable donation cards and care cards. The charitable donation card/care card administration system 400 includes various entities representing individuals, groups, and subsystems as indicated below.

The charitable donation card/care card administration system 400 includes a charity 401, which represents the entity that desires to issue charitable donation cards and care cards. According to one embodiment of the invention, a charitable donation card that the charity 401 wants to issue can be the charitable donation card as described above in reference to FIG. 1. In order to create a charitable donation card, the charity 401 interacts with a charitable donation card administrator 403 to set up the parameters for the charitable donation card. The charitable donation card administrator 403 can be responsible for the design, sale, and distribution of charitable donation cards. Charitable donation card parameters include such things as the physical design of the charitable donation card, including form factor, graphics, and charitable donation card purpose. The charity 401 can also interact with the charitable donation card administrator 403 in order to plan how the charitable donation cards will be sold and distributed. The charitable donation card administrator 403 interacts with a charitable donation card issuer 405 in order to physically create and distribute the charitable donation cards. If a charity 401 so desires, it can partner with a sponsor 409 in the funding and issuing of charitable donation cards. For example, a charity 401 might partner with a corporate sponsor to help fund a charity event associated with a charitable donation card. Once the charitable donation card has been designed, one or more donors 407 can interact with the charity 401 to directly or indirectly purchase charitable donation cards from the charity, for example at a charity event or on a website. The charity 401 interacts with the charitable donation card issuer 405 and the charitable donation card administrator 403 to sell and distribute charitable donation cards to donors 407. Alternatively, the charitable donation card issuer 405 can issue charitable donation cards directly to the charity 401, which will then sell (or have sold) or distribute the charitable donation cards directly to donors.

The sale or distribution of charitable donation cards is used to fund charitable giving. Specifically, in one embodiment, funds collected from the sale of charitable donation cards can be used to fund care cards that will be distributed to those who qualify. In order to obtain a care card a donee 411 (i.e., an intended beneficiary of the charity) interacts with a care card registry 413 to qualify and/or apply for care card. The care card registry 413 can be a website, for example, or a telephone hotline. The care card registry 413 obtains information from the donee 411 and communicates with a care card administrator 417 to determine if the donee 411 is qualified for a care card. If so, the care card administrator 413 interacts with a charity-sponsored debit card issuer 415 to issue a care card to the donee 411. In one embodiment, the care card registry 413, the care card administrator 417 and the care card issuer, are the same entity. In a second embodiment of the invention, the care card administrator 417 is a bank, credit card company, third party claims administrator, or other financial institution.

In one embodiment, the care card administration 417 interacts with the care card registry 413 to determine if the donee 411 qualifies for a care card. In one embodiment of the invention, the care card administration 417 monitors purchases made by the donee 411. The care card administration 417 can interact directly with donee 411, for example by collecting receipts from the donee 411 to verify expenses. Alternately, care card administration 417 can interact directly with merchants 419. Merchants 419 can be retailers or medical care providers, for example. Verification can, for example, happen electronically (e.g., using a credit card machine) or by the merchant 419 calling the care card administrator 417. In one embodiment, donee 411 goes to a merchant 419 and attempts to purchase items or pay for a service. Merchant 419 then interacts with care card administration 417 to verify that the card is valid and that the expense is allowed. For example: A charity, Charity, goes to a charitable donation card/care card creator/administrator, Charity Card Administrator. Charity wants to create a program where medical care cards are distributed to needy cancer patients. Charity then uses Charity Card Administrator to design charitable donation cards for the program. Charity Card Administrator performs several functions in this example: it creates, distributes, and administrates the charitable donation cards. It also creates, distributes, and administrates the care cards that are to be distributed to needy cancer patients. Charity and Charity Card Administrator determine all the details for Charity's program, including design and administration details. Next charitable donation cards are designed and created. Once the charitable donation cards have been designed and created by Charity Card Administrator, Charity sells (or has others sell) them to donors. The funds from the sale of the charitable donation cards go to Charity Card Administrator to fund care cards as needed. Needy cancer patients can directly or indirectly apply for the care cards, either through the Charity or Charity Card Administrator or can be distributed in other ways (e.g., distribution in the hospital ward). Qualifying information is obtained from the cancer patients and care cards are issued to qualified people. The cancer patients then use their care cards to pay for certain expenses (e.g., medical expenses). When the card is presented to the patients' medical practitioner, Charity Card Administrator is contacted to verify the card is valid and funded.

A charity is typically a non-profit entity, such as a health-based foundation (American Cancer Society; Links in Pink, Red Cross, etc.) In one embodiment, the charity is an entity satisfying the requirements of 501 (c) of the U.S. tax code. The charity can also be a university or college, or a for-profit entity that wish to distribute the care cards for charitable purposes.

Pharmaceutical companies distribute billions of dollars in free drug samples, which are intended, in part, to help the uninsured and people with low income. A care card can be use as (i) a card restricted to a particular drug, (ii) medical care card for any drug offered by a company/organization, (iii) a card for certain medical expenses (e.g., expenses relating to a particular illness which can feature a drug), or (iv) a card for medical expenses generally (which can feature a drug).

In one embodiment, a care card can be limited to acquisition of drugs (either a particular drug or any group or class of drugs). In one particular embodiment, a care card can replace traditional free sample drugs and be distributed through the care card registry, directly through hospitals and clinics, doctors, governmental agencies or other type of distribution facilitators. In such case, the care card can be referred to as a drug sample card. For example, a charity or a for-profit organization could distribute drug sample cards that enable a recipient to acquire certain drugs. Advantageously, the use of drug sample cards facilitates greater controls and security with respect to distribution on drugs. The drug sample cards are uniquely identified and can be tracked electronically so that the drug samples are properly distributed as intended.

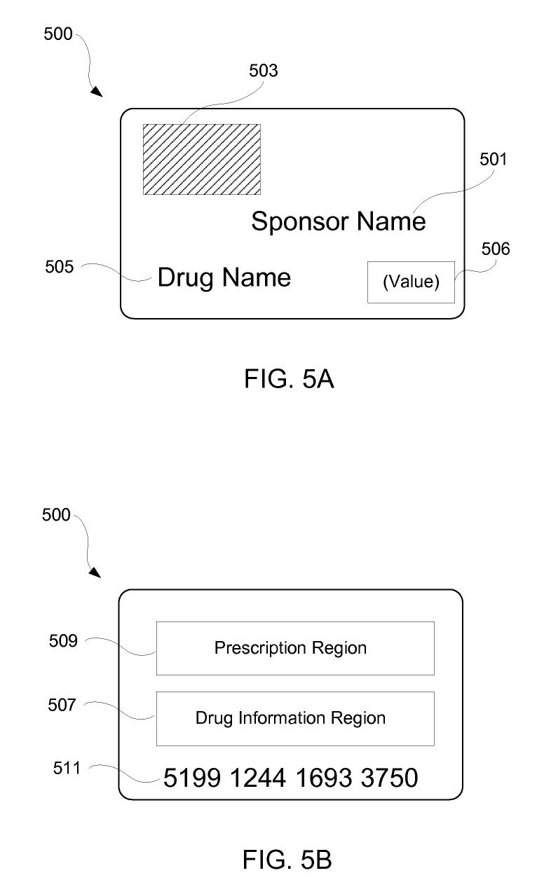

FIGS. 5A and 5B are diagrams of a drug sample card 500 according to one embodiment of the invention. FIG. 5A illustrates a front side of the drug sample card 500, and FIG. 5B illustrates a backside of the drug sample card 500.

A drug sample card 500 can be used to distribute drug samples to recipients. Although the drug sample card 500 can initially be distributed to a registry, hospitals, clinics, doctors, pharmacies, agencies or other facilitators for distributions and users, it is the end users that are intended to receive the drugs that can be obtained through use of the drug sample card 500. For example, an end user in need of a particular drug might visit a doctor who has available for distribution a drug sample card 500. In this example, the doctor can prescribe the drug for the patient through use of the drug sample card 500. In doing so, the doctor is authorizing the patients to receive a certain quantity or dollar amount of the drugs associated with the drug sample card 500.

According to one embodiment comment the drug sample card 500 can include a sponsor name 501. The sponsor name 501 can pertain to a doctor, a pharmacy, a pharmaceutical company that produces the drug, a charity, or other organization. In one implementation, the sponsor name 501 is the name of a pharmaceutical company producing the drug that is available through use of the drug sample card 500. A pharmaceutical company can then distribute the drug sample card 500 to its network of doctors, hospitals or clinics, or other organization for promotion of the particular drug. As illustrated in FIG. 2A, the drug sample card 500 can also provide a graphical image 503 and a drug name 505. The graphical image 503 can be an image associated with the sponsor name 501 or drug name 505. For example, the sponsor may have a corporate logo that can be utilized as the graphical image 503. As another example, the particular drug associated with the drug sample card 500 can have a logo or trademark that can be utilized as a graphical image 503. The drug sample card 500 can also include an indicator 506 of the value of the drug sample card 500. In one implementation, the value of the drug sample card 500 is provided in terms of a quantity of the drug (e.g., x tablets or y-day supply). In another implementation, the value of the drug sample card 500 can be provided in terms of a monetary amount (e.g., dollars), which can be used to purchase the drug.

Additionally, the backside of the drug sample card 510 can include a drug information region 507, a prescription region 509, and a unique card identifier 511. The drug information region 507 can include information that describes the drug's usage, risks and/or warnings. The prescription region 509 can provide a prescription template that can be completed by a doctor that is prescribing the drug by way of the drug sample card 500. Here, in one embodiment, the prescription associated with the distribution of the drug can be provided in the prescription region 509. In one implementation, the distributing doctor can complete the prescription template on the backside of the drug sample card 500 so that the drug can be distributed. The prescription can pertain to only the drug associated with the sample drug card 500 to the extent permitted by the drug sample card 500, or the prescription can facilitate the prescribing of additional quantities of the drug beyond that available using the drug sample card 500. For example, if the doctor desires to prescribe two weeks of a particular drug, at one tablet per day, the prescription can indicate approval for 14 tablets, and if the drug sample card 500 permits in the recipient to receive four free tablets, the prescription can allow the recipient is to receive the additional 10 tablets, though the recipient would be required to pay for the additional tablets. The unique card identifier 511 can be provided as an alphanumerical string as shown in FIG. 5B. Alternatively, the unique card identifier 511 can be, provided as a barcode or some other computer readable identifier (e.g., magnetic stripe). The unique card identifier 511 is utilized to redeem the card. The unique card identifier 511 can also be used to track the distribution as well as redemption of the card. For example, the unique card identifier 511 can be used to track the drug sample card 500 from a card manufacturer or sponsor, to a distributor (doctor, hospital, clinic, etc.), and then to a pharmacy for distribution to a particular end user. Hence, available tracking can be used to track one or more of: frequency of drug use, patient subsequent usage of the drug (after samples consumed), prescribing doctor/issuer, and/or end user.

In one embodiment, a drug care card can be activated or registered. For example, when a distributor is provided with a set of drug sample cards, the cards can be linked to the particular distributor. A distributor can activate cards online or via telephone. Later, an end user, the distributor or an intermediate distributor can register a particular drug sample card for a particular end user.

According to one particular example of activation/registrations, an electronic activation process (e.g., on-line or telephone) for the doctors office, sales representatives, pharmacist, or other distribution channel (e.g., event) to register a drug sample card. First, a distributor can register the doctor, if applicable, and authorized card identifiers (codes). Second, the doctor's office can prescribe the drug (either through activation of the card or a traditional prescription) and possibly enter the patient name, doctor code and card number (including possible passcode). Then the patient, through an on-line registration process, can enter the card number (including possible passcode), name, and other customized data that the drug company wishes to track.

In another embodiment, the care card discussed above can be for an individual or group, instead of a charity. For example, a card can be an “education card” that be used to coordinate and manage giving of money towards education expenses of a particular individual or set of individuals. For example, a grandparent can buy an education card having a value of $500 USD to give to a grandchild. The education card can then be used at an educational entity to pay for tuition, books and/or supplies. Hence, in one embodiment, the education card usage can be limited to “educational” purchases. For example, a charity or a for-profit organization could donate one hundred (100) care cards worth $100 each for purchase of one of the following items—eye glasses, books, clothing, computers/electronics, musical instruments—for students of an elementary or middle school in a low-income area.

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A charitable donation card, comprising:
a name of a charity;
a donation amount; and
a unique card identifier assigned to said charitable donation card.

2. A charitable donation card as recited in claim 1, wherein said charitable donation card further comprises:
a charitable purpose associated with said charitable donation card.

3. A charitable donation card as recited in claim 2, wherein said charitable purpose is for general utilization by the charity.

4. A charitable donation card as recited in claim 2, wherein said charitable purpose is for a specific charitable purpose.

5. A charitable donation card as recited in claim 2, wherein the specific charitable purpose pertains to a charitable event.

6. A charitable donation card as recited in claim 2, wherein the specific charitable purpose pertains to a particular person available for charitable assistance from the charity.

7. A charitable donation card, comprising:
a name of a charity;
an electronic circuit for storage of a donation amount; and
a unique card identifier assigned to said charitable donation card.

8. A charitable donation card as recited in claim 7, wherein said electronic circuit can store subsequent donation amounts placed on said charitable donation card.

9. A charitable donation product associated with a charity, comprising:
a charitable donation card designating at least a charity name of the charity and a donation amount represented by said charitable donation card; and
a token item indicating association with the charity.

10. A charitable donation product as recited in claim 9, wherein said charitable donation product is sold for a purchase price, and wherein the donation amount is less than the purchase price.

11. A charitable donation product as recited in claim 9, wherein said charitable donation product is sold for a purchase price, and wherein the donation amount is less than the purchase price by the fair market value of said token item.

12. A product associated with a charity, comprising:
a charitable donation card designating at least a charity name of the charity and a donation amount represented by said charitable donation card; and
a gift item.

13. A care card, wherein the charity-sponsored debit card is funded by charitable donations.

14. The care card of claim 13, wherein the charitable donations come from the sale of charitable donation cards (or sale of the care cards themselves to donors who gift them to donees).

15. The care card of claim 13, wherein the charitable donations come from the sale of the cards themselves to donors who gift them to donees.

16. The care card of claim 13, wherein the charity-sponsored debit card displays custom graphics.

17. The care card of claim 13, wherein the care card is for medical expenses (e.g., drugs, hospital bills, surgery, rehabilitation, medical tests (e.g., mammogram).

18. The care card of claim 13, wherein the care card is for groceries, housing expenses, household expenses, child-care, or home repairs.

19. The care card (or donation card) of claim 13, wherein charitable donations are matched by a corporate donor.

20. The care card of claim 13, wherein a specific class of donees is authorized to use the care card.

21. The care card of claim 13, wherein a donee wishing to use a charity-sponsored debit card must register the charity-sponsored debit card before the first use.

22. The care card of claim 13, wherein the charity is an educational entity.

23. A drug sample card for facilitation distribution of a drug, said drug sample card capable of being utilized to obtain the drug.

24. A drug sample card as recited in claim 23, wherein said drug sample card comprises sponsor information, drug information and a unique card identifier assigned to said drug sample card.

25. A drug sample card as recited in claim 23, wherein said drug sample card comprises a drug prescription region.
